(19) United States
(12) Patent Application Publication
(10) Pub. No.: US 2004/0204964 A1
(43) Pub. Date: Oct. 14, 2004

(54) Method and apparatus for importing healthcare related information from a physician office management information system

(76) Inventors: Erik Andrew Moore, Foster City, CA (US); Jeffrey Todd Smith, San Francisco, CA (US)

Correspondence Address: John W. Godschmidt, Jr., Reed Smith LLP, 2500 One Liberty Place, 1650 Market Street, Philadelphia, PA, 19103, US

(21) Appl. No.: 10/827,719

(22) Filed: Apr. 20, 2004

Related U.S. Application Data
(63) Continuation of application No. 09/635,876, filed on Aug. 10, 2000, now abandoned.
(60) Provisional application No. 60/169,099, filed on Dec. 6, 1999.

(51) Int. Cl. G06F 17/60

(52) U.S. Cl. 705/2; 705/9

(57) ABSTRACT

An apparatus and method of retrieving healthcare information. The method includes connecting a portable computer to a physician office management information system. The physician office management information system stores healthcare related information including at least patient identifiers and upcoming patient appointment times. A terminal of the physician office management information system is emulated to obtain emulated healthcare related information. Patient identifiers and upcoming patient appointment times are scraped from the emulated healthcare related information into a memory of the portable computer.

### CROSS-REFERENCE TO RELATED APPLICATIONS

This application claims priority under 35 U.S.C. 119(e) to U.S. Application Serial No. 60/169,099, filed Dec. 6, 1999 and entitled Handheld Method and Apparatus for Managing Health Care Information.

### BACKGROUND OF THE INVENTION

1. Field of the Invention

The present invention relates to a method and apparatus for managing healthcare related information, and more particularly to a method and apparatus for importing healthcare related information to portable computers from a physician office management information system.

2. Description of the Related Art

Patient demographic and patient scheduling in physicians' offices and other medical treatment facilities are currently organized and saved on physician office management information systems. Physicians and other individuals access physician office management information systems to retrieve patient demographic and patient scheduling information. Because physicians utilize the patient demographic and patient scheduling information stored in physician office management information systems when performing healthcare related tasks, such information is typically printed or manually copied from the system display for viewing by physicians. If a physician is required to perform a health related task for a particular patient, such as generating prescriptions, hospital admission forms, or order sets, the physician often manually transcribes the information to paper forms from a printout or display of the physician office management information system. Although most physician office management information systems allow physicians to access and print all of the information maintained within the database of the system, it is cumbersome for physicians to carry numerous printed records of various patients throughout the day. Moreover, as scheduling and patient information changes throughout a given day, physicians must manually update the previously printed records or update and print new records.

Many physicians utilize portable computers to carry out health related tasks. If a physician desires to use the information from the physician office management information system on the portable computer, the information from the physician office management information system must be manually input into the portable computer. This is a burdensome task that is prone to data entry error. Moreover, it is not practical to download healthcare related information from the physician office management information system to the portable computer for use by the physician because existing physician office management information systems resident at physician offices are not configured to download information to the portable computers that physicians use to carry out health related tasks. For example the MEDIC system and the MEDICAL MANAGER system (UNIX based operating systems), like most existing physician office management systems, are not configured to download information to a PALM operating system, a WINDOWS operating system, or even a UNIX operating system of a portable computer. That is, existing physician office management systems are stand-alone systems that are not designed to exchange information with third party products. Hence, physicians have not been able to import to portable computers the information stored on existing physician office management information systems. Rather, physicians must manually enter this information into portable computers.

It will thus be appreciated that it is particularly difficult for physicians to utilize information from physician office management information systems, especially when performing health related tasks with portable computers.

### SUMMARY

In an effort to address the aforementioned problems, the embodiments of the present invention strive to provide apparatus and methods whereby physicians can carry out healthcare tasks, such as generating prescriptions, with portable computers utilizing at least some information imported from physician office management information systems.

Other objects, advantages and features associated with the embodiments of the present invention will become more readily apparent to those skilled in the art from the following detailed description. As will be realized, the invention is capable of other and different embodiments and its several details are capable of modification in various obvious aspects, all without departing from the invention. Accordingly, the drawings and the description are to be regarded as illustrative in nature, and not limitative.

### BRIEF DESCRIPTION OF THE DRAWINGS

FIG. 1 is a schematic of a healthcare management system in accordance with one embodiment of the present invention.

FIG. 2 is a schematic of another embodiment of a healthcare management system of the present invention.

FIG. 3 is a schematic of a further embodiment of a healthcare management system of the present invention.

FIG. 4 is a schematic of a further embodiment of a healthcare management system of the present invention.

FIG. 5 is a flow diagram illustrating one embodiment of a method according to the present invention.

FIG. 6 is a flow diagram illustrating another embodiment of a method according to the present invention.

FIG. 7 is an example of an import display produced on a portable computer of the system illustrated in FIG. 1.

FIG. 7a is an example of a communication setup display produced on a portable computer of the system illustrated in FIG. 1.

FIG. 8 is an example of an import settings display produced on a portable computer of the system illustrated in FIG. 1.

FIG. 9 is an example of a log-on display produced on a portable computer of the system illustrated in FIG. 1.

FIG. 10 is an example of a schedule display produced on a portable computer of the system illustrated in FIG. 1.

FIG. 11 is an example of a prescription creation display produced on a portable computer of the system illustrated in FIG. 1.

FIG. 12 is an example of an emulated log-in display of one embodiment of a physician office management information system.

FIG. 13 is an example of an emulated menu display of one embodiment of a physician office management information system.

FIG. 14 is an example of an emulated appointments detail report query display of one embodiment of a physician office management information system.

FIGS. 15 and 16 are examples of emulated appointment detail report displays of one embodiment of a physician office management information system

FIG. 17 is an example of an emulated patient information query display of one embodiment of a physician office management information system.

FIG. 18 is an example of an emulated detailed patient display of one embodiment of a physician office management information system.

FIG. 19 is an example of an emulated insurance information display of one embodiment of a physician office management information system.

### DETAILED DESCRIPTION

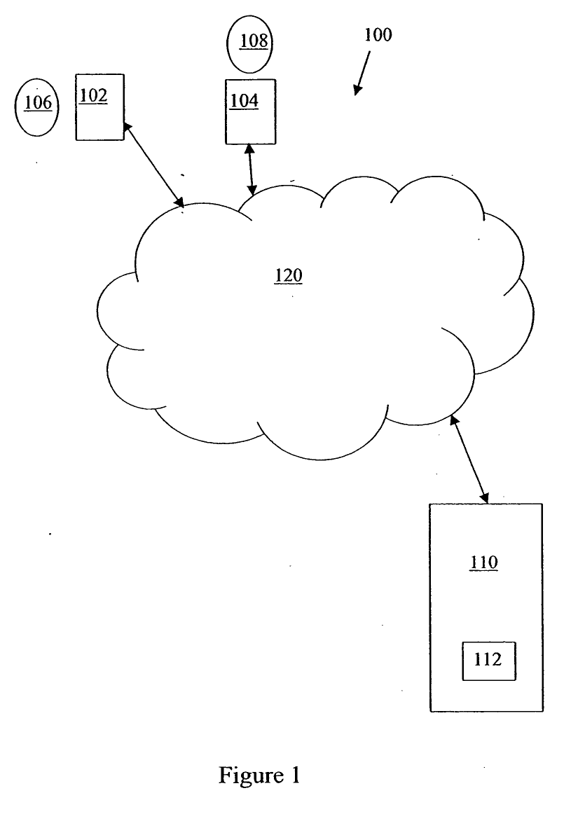

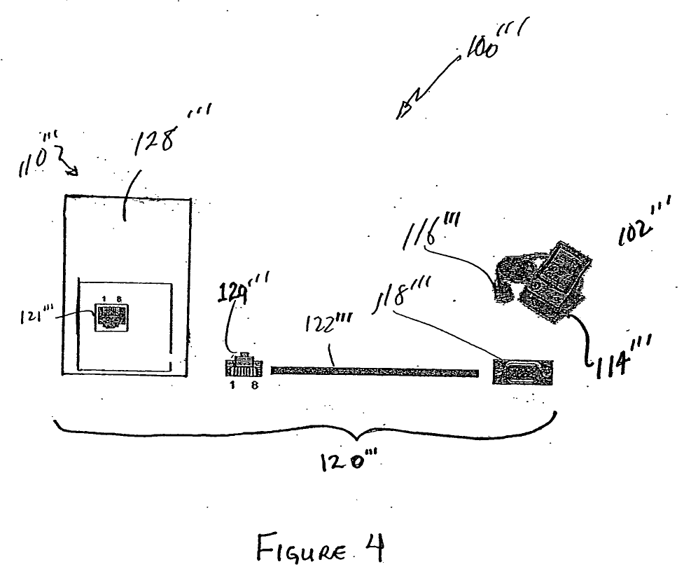

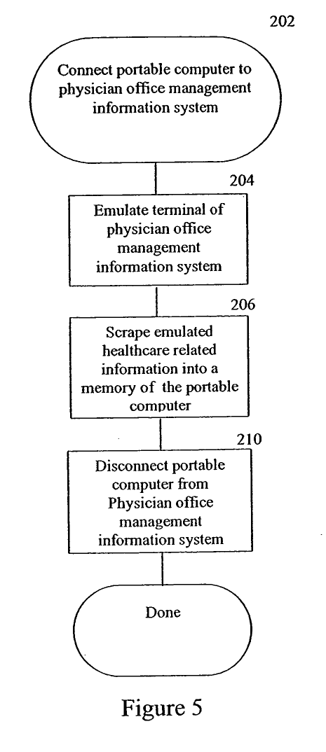

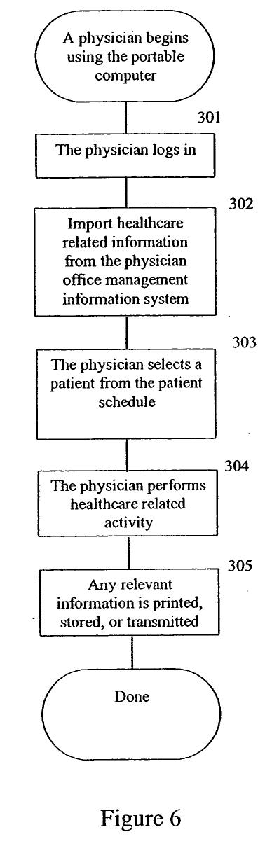

FIG. 1 illustrates one embodiment of a healthcare management system 100 suitable for implementing the features of the present invention, and FIGS. 5 and 6 illustrate flow charts of exemplary methods of the present invention. The healthcare management system 100 includes one or more portable computers 102, 104, a physician office management information system 110, and a network 120 connecting the portable computers 102, 104 with the physician office management information system 110. As described further below, physicians 106, 108 may retrieve healthcare related information from the physician office management information system 110 over the network 120 for use on the portable computers 102, 104.

The portable computers 102, 104 are each operable by a physician 106, 108, and each include a user input/output, a display, and a memory. The portable computers 102, 104 are each configured to run software to view healthcare related information (such as patient demographic information, diagnosis information, drug lists, interactions, patient appointment schedules, etc.), which may be retrieved from the physician office management information system 110 over the network 120. As described below, the user interface rendered on the portable computers 102, 104 also enables the physicians 106, 108 to carry out various healthcare related activities, including creating electronic or paper prescriptions. Hence, the portable computers 102, 104 are devices by which each physician 106, 108 can view information of patients and preferably create an electronic or paper prescription for the patients, preferably at the point-of-patient-care (the location where the patient is being diagnosed).

Suitable implementations of portable computers 102, 104 include devices such as laptop computers, wired or wireless telephones, portable workstations, personal data assistants (“PDA's”), pagers, and various other portable electronic communication devices capable of carrying out healthcare related activities. Exemplary portable computers 102, 104 include devices commercially available from suppliers such as iScribe, Inc., San Mateo, Calif., USA. Furthermore, U.S. Pat. Nos. 5,884,273, 5,737,539 and 5,561,446, the entire disclosures of which are hereby incorporated by reference, describe the structure and operation of suitable portable computers. Each physician 106, 108 has his or her own portable computer 102, 104. Alternatively, the healthcare management system 100 may include only one portable computer 102 for use by one physician 106 or for use by a number of different physicians 106, 108.

A prescription created by one of the portable computers 102, 104 may be in electronic form for direct transmission over the network 120 to a prescription provider, such as a pharmacy, or may be a paper prescription printed from a stand alone printer or a printer connected to the network 120. A prescription created by each portable computer 102, 104 preferably includes among its constituent of elements a patient identifier, a prescription drug identifier, and an identifier of the prescribed drug quantity. The patient identifier may include, but is not limited to, a patient name, a patient social security number, a patient password, a patient health insurance plan identifier, a patient pharmacy benefit identifier, a patient e-mail address, a universal patient identifier, or any other identifier or combination of identifiers distinguishing one particular patient from other patients.

The prescription drug identifier may include, but is not limited to, a drug name, a drug number, a drug code, or other information uniquely identifying the prescribed drug. The embodiments of the present invention apply to the prescription of drugs in general, which include any physiologically or pharmacologically active substance prescribed by a physician, including over-the-counter drugs. The prescribed drug may be any of the agents that are known to be delivered to humans or animals, such as medicaments, vitamins, nutrients, or the like. Drugs that may be prescribed in the context of the present invention include drugs that are prescribed to treat any variety of medical conditions. A few examples of prescribed drugs include, but are not limited to, drugs sold under the trade names Allegra, Ceflin, Celebrex, Claritin, Erythromycin, Levaquin, Prinivil, Pravachol, Viagra, Zofran, etc. The drug may be prescribed alone or in combination with an apparatus, such as a sustained release drug delivery system or other drug delivery apparatus.

The prescription created by each portable computers 102, 104 further includes an identifier of the prescribed drug quantity, which is some indication of the amount of drug that the physician is prescribing to the patient.

While the prescription created by the respective portable computers 102, 104 at least includes identifiers of the patient, the prescribed drug, and the prescribed drug quantity, the prescription can include other information as well. For example, the prescription may include any of the following information typically required by many government regulations:

patient name;

patient address;

physician name;

physician address;

physician phone number;

DEA number;

date of issuance;

prescribed drug strength;

prescribed drug dosage form (capsule, pill, etc.);

intake method or route of administration (orally, injectable, etc.);

frequency (Q6h, Q8h, monthly, etc.);

directions for use;

number of refills allowed;

permissible substitutes;

license classification;

degree classification;

license number; and

diagnosis.

Network 120 may be any form of interconnecting network including an intranet, such as a local or wide area network, or an extranet, such as the World Wide Web or the Internet. Network 120 can be physically implemented on a wireless or wired network, on leased or dedicated lines, including a virtual private network (VPN).

The physician office management information system 110 is a system that stores healthcare related information to assist in managing physician offices or other medical treatment facilities. Hence, the physician office management information system 110 includes a memory 112 that stores healthcare related information, and preferably includes one or more servers, computers, or other electronic devices capable of receiving and storing healthcare related information. Suitable physician office management information systems 110 are also referred to as “physician practice management systems”, and include systems such as: MEDICAL MANAGER, MEDIC, LYTEC, MEDISOFT, etc. In one embodiment, the physician office management information system 110 is a WINDOWS based system. In another embodiment, the physician office management information system 110 is a PALM based system. In yet a further embodiment, the physician office management information system 110 is a UNIX based system. The physician office management information system 110 may also be internet-based and generate web-browser and web page data, such as HTML, JavaScript, Java applets, etc. Examples of typical functions performed by suitable physician office management information systems include any one or combinations of the following:

new patient entry;

procedure entry;

payment posting;

display patient data;

report generation;

billing and EDI;

file maintenance;

office management;

system utilities;

electronic chart;

prescription creation;

lab result entry; and

referral information entry.

The healthcare related information stored by the physician office management information system 110 at least includes patient identifiers of different patients, as described above, and patient appointment times. The patient appointment times are times at which a patient has an appointment with one or more particular physicians on a particular day or days. Future patient appointment times, i.e., those that have not occurred, are termed “upcoming patient appointment times.” The upcoming patient appointment times and the patient identifiers together define future patient appointment schedules. Although the physician office management information system 110 at least stores patient identifiers and patient appointment times, it preferably stores other information as well. For example, the physician office management information system 110 may store any combination of the following information:

patient identifiers;

upcoming patient visit dates

upcoming patient visit times;

past patient visit dates and times;

patient phone numbers;

patient addresses;

patient date of births or age;

patient sex;

patient insurance carrier;

patient insurance plan number;

past illnesses;

previous treatments;

drug allergies;

current medications;

contact information;

prior hospital admissions;

upcoming hospital admissions;

upcoming routine exams;

patient insurance information;

lab results;

billing information; and

diagnoses.

Any one of or combinations of the above-described healthcare related information stored by the physician office management information system 110 may be communicated to the portable computers 102, 104 over the network 120 in the manner described in greater detail below.

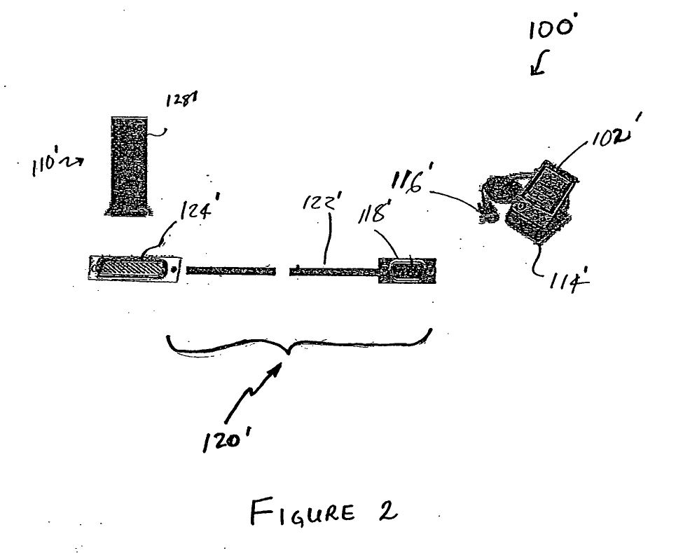

FIGS. 2-4 illustrate alternative embodiments of the healthcare management system 100. As will be realized, the many features and functions of the healthcare management system 100 illustrated in FIG. 1 also apply to the healthcare management systems 100′, 100″, 100′″ illustrated in FIGS. 2-4. Hence, the healthcare management systems 100′, 100″, 100′″ illustrated in FIGS. 2-4 have been assigned corresponding reference numbers (with one or more primes “′”)as the healthcare management system 100 illustrated in FIG. 1. The systems illustrated in FIGS. 2-4 also include many additional features and inherent functions, as described further below.

As illustrated in FIGS. 2-4, the healthcare management systems 100′, 100″, 100′″ each include a network 120′, 120″, 120′″, a portable computer 102′, 102″, 102′″, and a physician office management information system 110′, 110″, 110′″ that each include a server 128′, 128″, 128′″. In the embodiments illustrated in FIGS. 2-4, each portable computer 102′, 102″,102′″ is a PALM based PDA or a WINDOWS CE based PDA. Each portable computer 102′, 102″, 102′″ is connectable to the respective network 120′, 120″, 120′″ by connecting the portable computer 102′, 102″, 102′″ to a cradle 114′, 114″, 114′″, which is part of the respective network.

Within the network 120′, the cradle 114′ is connected to the physician management system 110′ via male and female connectors 116′, 118′, hardwire 122′ and port 124′.

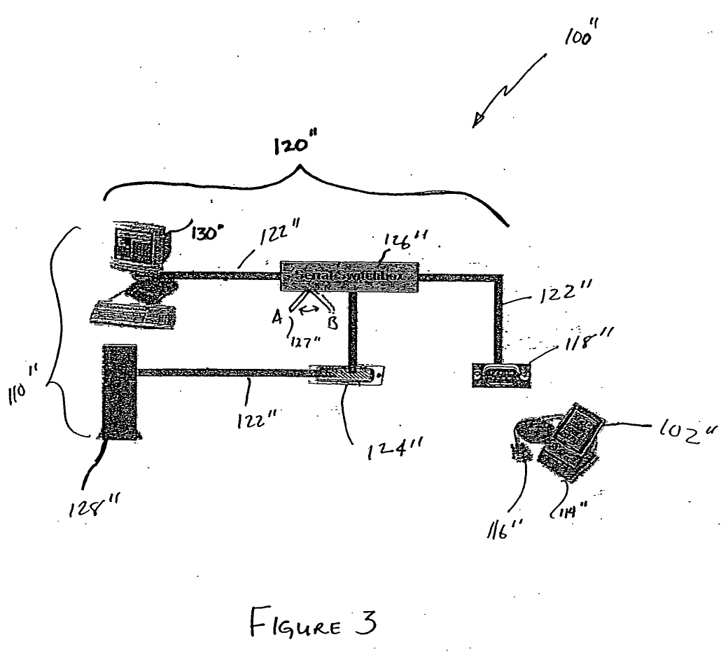

Within the network 120″, the cradle 114″ is connected to the physician management information system 110″ via male and female connectors 116″, 118″, hardwires 122″, a port 124″, and a switch box 126″. As illustrated in FIG. 3, the physician office management information system 110″ also includes a terminal 130″. The terminal 130″ is an electronic display configured to display the information stored in the physician office management information system 110″. Hence, the terminal 130″ is in communication with the server 128″ of the physician office management information system 110″. Because many or all of the access ports of the server 128″ of the physician office management information system 110″ may be occupied by terminals, the network 120″ includes the serial switch box 126″. The serial switch box 126″ includes a manual switch 127″ that, when in a first position A, establishes a connection between the terminal 130″ and the server 128″, and, when in a second position B, establishes a connection between the portable computer 102″ and the server 128″. Hence, the serial switchbox 126″ functions as an access port to the server 128″ of the physician office management information system 110″ when in the second position B, where the connection between the terminal 130″ and the server 128″ is broken.

As illustrated in FIG. 4, the cradle 114′″ of the network 120′″ is connected to the physician information management system 110′″ via male and female connectors 116′″, 118′″, hardwires 122′″, and a port 121′″. Connector 129′″ includes a null modem adapter coupled to a remote asynchronous node on server 128′″.

In further embodiments of the healthcare management system 100, the portable computers 102 are connected to the physician office management information system 110 by other hardwire configurations, as well as by wireless networks (infrared, radio, etc.).

The following description of the operation of the healthcare management information system 100 describes the function and interaction of the physician 106 and the portable computer 102 with the remainder of the system 100 illustrated in FIG. 1. However, it is to be understood that the following description is equally applicable to the physician 108 and portable computer 104, multiple other physicians and portable computers not illustrated in FIG. 1, and the healthcare management information systems 100′, 100″, 100′″ illustrated in FIGS. 2-4.

One method of the present invention will now be described in reference to FIG. 5. As will be apparent, the steps illustrated in FIG. 5 need not occur in the illustrated order. In the preferred embodiment, steps 204-206 repeatedly occur during the importation of healthcare related information to the portable computer 102. As illustrated by FIG. 5, at a step 202, the portable computer 102 is connected to the physician office management information system 110 via network 120. The portable computer 102 may be connected to the network 120 by a hardwire or wireless connection.

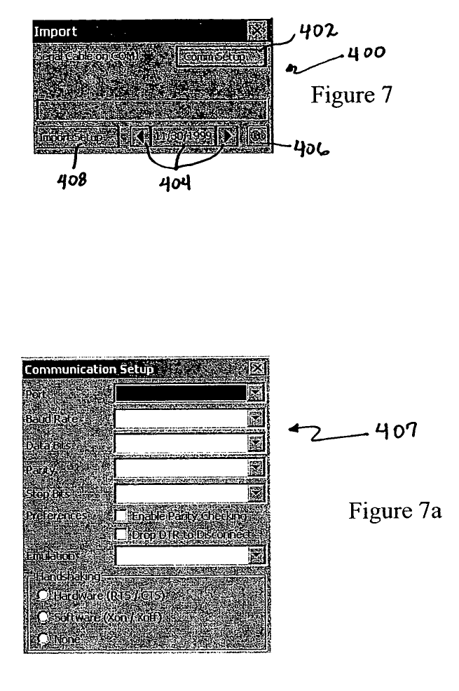

As illustrated in FIG. 7, the portable computer 100 presents an import display 400 for viewing by the physician 106. The import display 400 is an interactive display viewed by the physician 106 when the physician desires to import healthcare related information to the portable computer 102 from the physician office management information system 110. Hence, the portable computer 102 preferably includes computer executable software code stored on a computer readable medium of the portable computer 102 for prompting the physician 106 to import healthcare related information from the physician office management information system 110 to the portable computer. In the preferred embodiment, the import display 400 presents interactive icons 402, 404, 406, 408 that the physician 106 or other user may use to import the desired healthcare related information from the physician office management information system 110. For example, if the physician 106 desires to retrieve patient schedule information for a particular day or date, the physician 106 sets or selects the particular day via the interactive date icons 404. As illustrated in FIG. 7, the import display 400 also includes communication setup icon 402, which permits the physician 106 or other user to set communications requirements (such as communication speed, etc.) between the portable computer 102 and the physician office management system 110. The import display 400 also includes import setup icon 408, which permits the physician 106 or other user to set importation settings for proper terminal emulation, as described further below.

Once the portable computer 102 is connected to the physician office management information system 110 via the network 120, the physician 106 presses import icon 406, labeled “GO”, to initiate the importing of healthcare related information from the physician office management information system 110 to the portable computer 102. The portable computer 102 then, in a step 204, emulates a terminal of the physician office management information system 110 to obtain emulated healthcare related information. The portable computer 102 preferably includes computer executable software code stored on a computer readable medium of the portable computer 102 or downloadable into the portable computer that emulates a terminal of the physician office management information system 110. Terminal emulation is the ability of the portable computer 102 to appear to be a terminal of the physician office management information system 110 so that it can be used to interact with a server or computer of the physician office management information system 110, which typically has its own proprietary or standardized connection interface. That is, the portable computer 102 is used to simulate the type of terminal required to gain access to physician office management information system 110. Hence, the code resident on the portable computer 102, or resident at another location on the network 120, allows the portable computer to act like a particular type of terminal, e.g. a VT-100. The portable computer 102 thus appears as a terminal to the physician office management information system 110 and accepts and gives the proper sequence for routine functions.

During terminal emulation at step 204, the portable computer 102 essentially logs-on to the physician office management information system 110 and directly accesses the programs and healthcare related information stored in the physician office management information system 110. The terminal emulation program runs like any other workstation application as a separate program task on the portable computer 102 and provides its own window to the physician 106. This permits the physician 106 to briefly view the emulated information on the portable computer while the healthcare related information is scraped as described below. In an alternative embodiment, no emulated terminal window is presented to the physician during the terminal emulation and scraping of healthcare related information.

Different terminal emulation is typically required for different types of terminals. For example, the IBM 3270 display terminal or the AS/400's 5250 display terminal each require a different terminal emulation program. The program performing the terminal emulation understands the communication protocols and hence the emulated data stream from the physician office management information system 110 at several communication levels, including data link control and session control. Hence, depending on the physician office management information system 110 that is being accessed, (i.e., brand of system) the code is formatted in order to properly communicate with the specific brand or type of physician office management system being accessed. In the preferred embodiment, the type of terminal emulation is specified during the configuration of the portable computer 102, and the code resident on portable computer 102 appropriately formats the data stream. Further examples of specific terminals that may be emulated include IBM 3270, Wyse 60, IBM 3151, SCO ANSI, etc.

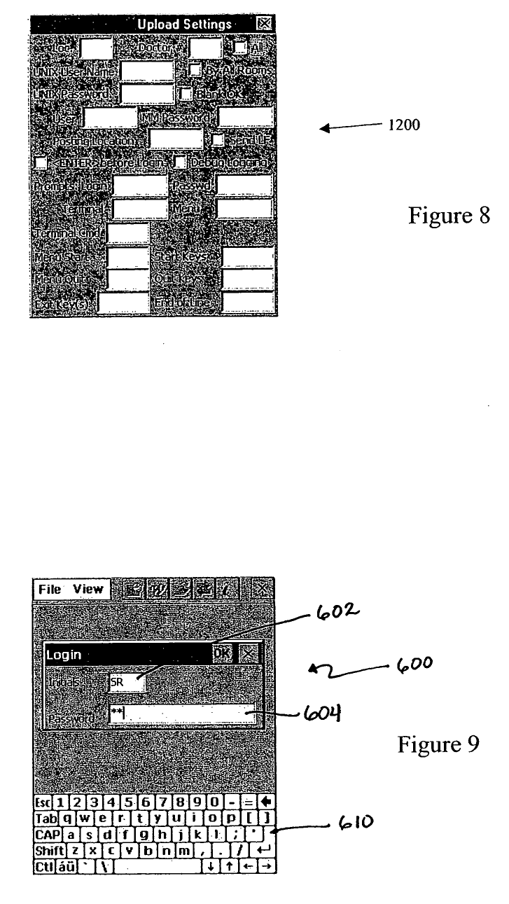

In order to perform terminal emulation, some physician office management information systems 110 require appropriate import settings, such as user names, logins, or other identifiers. In the preferred embodiment, the portable computer 102 permits the physician 106 or other individual to configure any required import settings. As illustrated in FIGS. 7 and 8, by pressing the import setup icon 408, the physician 106 or other individual is presented with an import setup display 1200 through which the user can set import settings used to emulate a terminal of the physician office management information system 110. As illustrated in FIG. 8, the exemplary import setup display 1200 is an interactive display through which the user may enter any settings that may be required to emulate a terminal of the physician office management information system 110. For example, the physician or other user may enter one or more of the following settings:

physician office management information system location;

physician identifier, such as physician number or name;

identifier for all physicians;

user name;

password;

identification of all rooms;

posting location;

“enter” before log-in;

log-in prompt;

terminal prompt;

password prompt;

menu prompt;

terminal command;

menu start;

menu quit;

start keys;

quit keys; and

end of line.

As illustrated in FIG. 7, the physician 106 or other user is also presented with communications setup icon 402, which, when activated, permits the user to set communication requirements, such as transmission speed and other particulars for the particular terminal emulation used. As illustrated in FIG. 7a, when the physician 106 or other user activates the communication setup icon 402, the portable computer presents communication setup display 407, which permits the user to enter the physical means of connection (e.g., serial port), baud rate, data bits, parity, stop bits, and handshaking. The terminal emulation software together with any inputs the physician 106 or other user enters through the portable computer 102 preferably includes instructions for how to emulate a terminal of the physician office management information system 110, both in terms of what information will travel back and forth between the portable computer 102, acting as the terminal, and the physician office management information system 110, and in terms of how that information is transmitted, such as transmission speed and the terminal emulation used. The terminal emulation used specifies information such as display formatting information for data transmitted by the physician office management information system 110 to the portable computer 102, which acts as a terminal, and information on how to format data corresponding to user submissions and queries that is transmitted by the portable computer 102 to the physician office management information system 110.

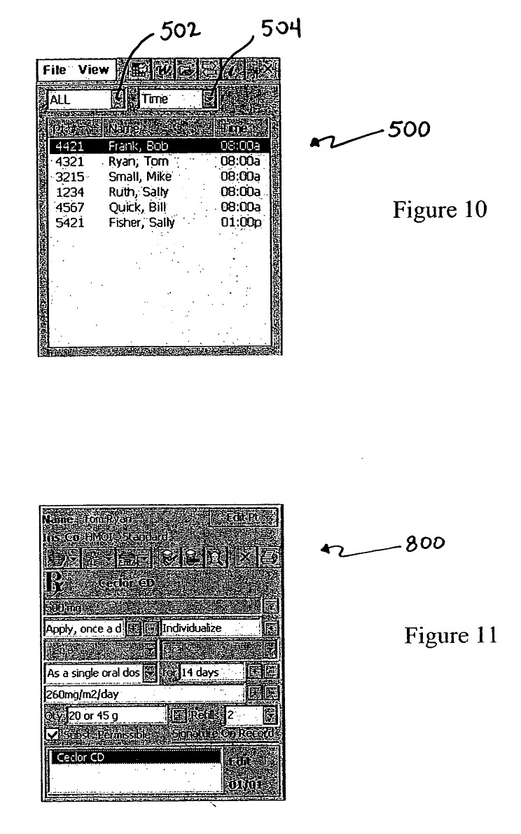

During or after specific terminal emulation steps, at a step 206, healthcare related information, such as patient identifiers and upcoming patient appointment times, is scraped from the emulated healthcare related information. Scraping is essentially programming that determines, identifies, or finds the location of one or more desired data fields of the emulated healthcare related information, in either the emulated data stream from the physician office management information system 110 or at a location on an emulated display, and then copies the information, or data string, from within the data field to a memory of the portable computer 102. Scraping of the emulated healthcare related information is performed by software on the portable computer 102 that scrapes emulated data transmitted by the physician office management information system 110. The software that performs the also identifies or finds the location and size of one or more emulated data fields corresponding to a patient identifier, a patient visit time, a patient visit date, patient insurance information, or any other emulated data field corresponding to one or more of the previously identified healthcare related information stored in the physician office management information system 110. During the terminal emulation step 204, any scraped healthcare related information is preferably stored in the dynamic memory of the portable computer 102. The scraping process utilizes the information retrieved and stored in memory to make decisions about the next set of information to retrieve. After the personal computer 102 has obtained all of the desired healthcare related information via the above-described terminal emulation and scraping processes, the scraped healthcare related information is then processed and stored in data structures of a persistent memory of the portable computer 102, such as RAM, hard disk, CD-ROM, floppy disk, or magnetic optical disk. In an alternative embodiment, the healthcare related information is intermittently scraped directly to the persistent memory of the portable computer 102 during emulation of a terminal at step 204. Each data string from each data field of emulated healthcare related information is scraped into an assigned or designated memory location that corresponds to the type of information scraped. For example, a data field of an emulated patient identifier is stored in a memory location in the portable computer 102 that corresponds to a patient identifier, while a data field of an emulated upcoming appointment time is stored in a memory location in the portable computer 102 that corresponds to an upcoming patient appointment time. Two or more memory locations can also be associated with each other. For example, a first memory location corresponding to a patient A's upcoming appointment time may be associated with a second memory location corresponding to patient A's identifier, rather than a memory location corresponding to a patient B's identifier. Hence, by storing each scraped data string into assigned or designated memory locations, the portable computer attaches an identifiable meaning to each portion of scraped information. The portable computer 102 can thus intelligently identify and retrieve each scraped data string stored in the respective memory location for later use. For example, the portable computer 102 can generate a patient schedule template, such as that illustrated in FIG. 10, by retrieving the information stored in memory locations corresponding to patient identifiers, retrieving the information stored in memory locations corresponding to upcoming patient appointment times, and arranging the retrieved information into a column of patient identifiers and an adjacent column of upcoming patient appointment times that correspond to the respective patient identifiers. The portable computer 102 can thus create display templates using the information stored in the respective memory locations. Because each scraped data string is stored in distinct and identified memory locations, the physician 106 or other user can also direct the portable computer 102 to format the stored information into any desired arrangement.

In the preferred embodiment, the physician 106 presses the import icon 406 to activate the terminal emulation and scraping process on the portable computer 102. The software running on the portable computer 102 will form a connection to the physician office management information system 110, transmit any relevant identification and authorization information, and then interactively query the physician office management information system 110 to scrape healthcare related information for use by the physician 106.

In a preferred embodiment, the software that performs the terminal emulation and scraping is preferably compiled in advance and includes instructions to conditionally send different queries to the physician office management information system 110 based on information received from the physician office management information system 110. For example, if the physician office management information system 110, in response to a query from the portable computer 102 running the terminal emulation software, transmits information to the portable computer indicating that a patient has an appointment to see the physician 106 sometime the next day, the software requests further information, such as the purpose of the appointment, the medical history of the patient, and/or the patient's insurance information. In a further embodiment, the software on the portable computer 102 performs a sequence of queries designed to successfully obtain desired healthcare related information if not readily available, such as finding insurance information for a dependent through the primary member under which the dependent is insured. Likewise, if a patient has an appointment with a physician to look at a possible ear infection, the software could query the physician office management information system 110 to find any antibiotics the patient has recently taken.

In an alternative embodiment, the software that performs the above-described terminal emulation and scraping with the physician office management information system 110 reads scripting information from a separate file not necessarily written prior to the time at which the software was compiled. Such a script file may include information on how to interact with the physician office management information system 110 to obtain a specific set of information through queries, as described above.

In a further embodiment, the physician 106 partially or completely directs the interaction with the physician office management information system 110 during the terminal emulation and sets the desired information to be scraped from the emulated healthcare related information. For example, the physician 106 may manually input some or all of the queries or responses that the portable computer 102, acting as an emulated terminal, sends to the physician office management information system 110. In this embodiment, the software need not need know the nature of the information that travels between the portable computer 102 and the physician office management information system 110—it only need know the terminal emulation used and the location of the healthcare information to be scraped. Alternatively, the physician 106 could be queried periodically by the terminal emulator software as to what healthcare related information the physician 106 desires to be scraped from the physician office management information system 110.

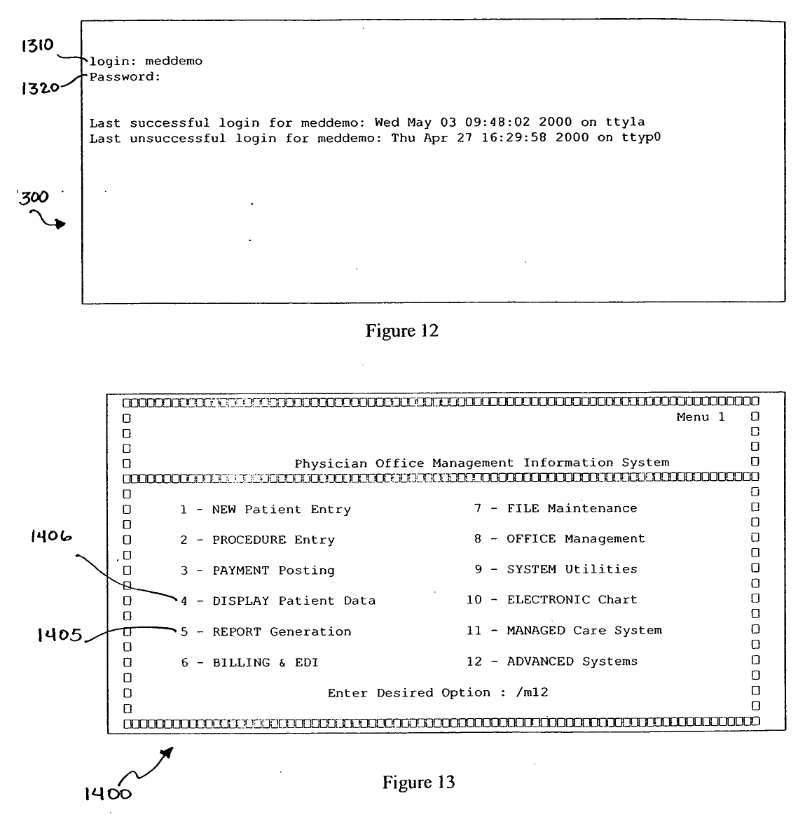

FIGS. 12-19 illustrate emulation displays or screens of one embodiment of a physician office management information system 110 (such as the MEDICAL MANAGER system), which the physician 106 would view during one embodiment of the previously described terminal emulation and scraping processes. FIG. 12 is an 20 exemplary emulated log-in display 1300 of the physician office management information system 110. At a log-in prompt 1310, portable computer 102 enters the appropriate login and password, which were previously set via the import settings display 1200. In an alternative embodiment, the physician 106 manually enters any required logins and passwords via the portable computer 102 during the terminal emulation process. In a further embodiment, any required log-ins and passwords are pre-programmed in the code of the portable computer 102.

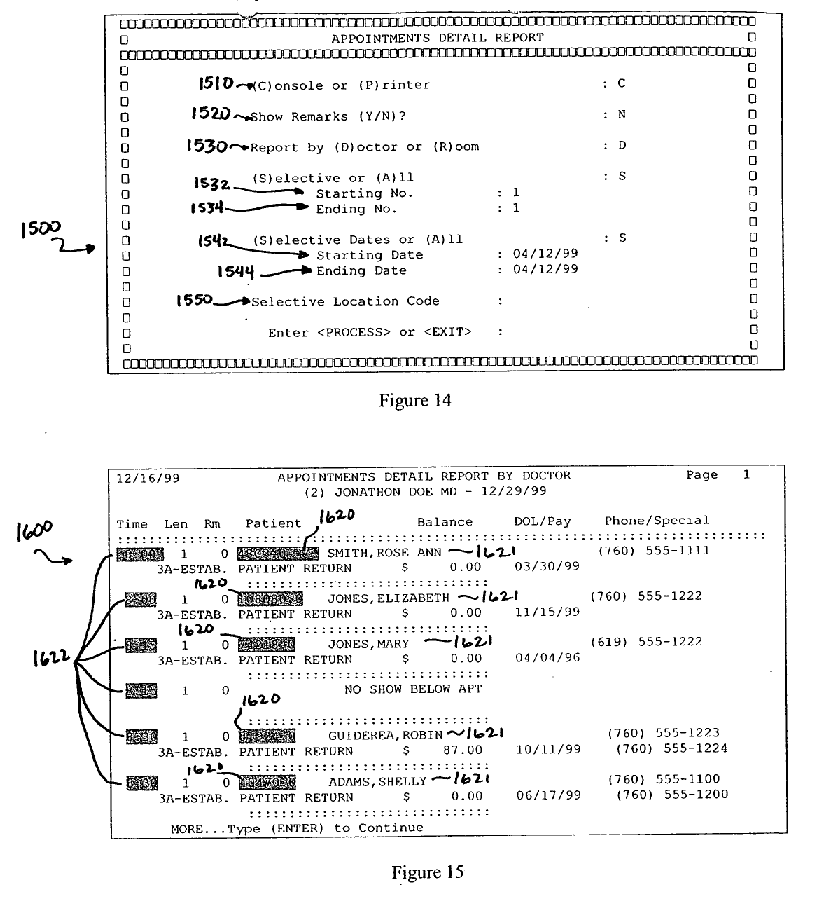

Once the access information has been appropriately communicated to the physician office management information system 110, the portable computer 102 then emulates the menu display 1400 illustrated in FIG. 13. To obtain a patient schedule, the portable computer 102 chooses the “report generation” option 1405 of the emulated menu display 1400, such that the portable computer 102 then emulates the appointments detail report configuration query display 1500 illustrated in FIG. 14. The emulated appointments detail report query display 1500 prompts a series of queries to configure a patient schedule report.

The portable computer 102 will communicate appropriate responses to the queries presented by the appointments detail report configuration query display 1500 based on the import settings previously entered in the import screen 1200. For example, the portable computer 102 will communicate a letter “C ” in response to the console or printer prompt 1510, indicating that the report is to be generated for a console (in this case the emulated terminal), rather than for a printer. The portable computer 102 will also communicate a “N” in response to the remarks prompt 1520, indicating that remarks are not to be included in the report. The portable computer 102 will also communicate a “D” in response to the “Report by Physician or Room” prompt 1530 so as to select a report organized by physician name rather than room number. The portable computer 102 may alternatively communicate a “R” to select a report organized by room number rather than physician.

Because the portable computer 102 has communicated a request for a report organized by physician, the portable computer 102 then communicates either an “S” (a request for a report for a specific or selective physician) or an “A” (a request for a report for all physicians in the POMIS system 110). In the illustrated embodiment, the portable computer 102 has communicated a “S” for a report for selective physicians. Hence, the portable computer 102 communicates one or more physician identifiers, such as a name, number code, password, etc., in response to the prompts 1532, 1534 so as to request a report specific to the identified physician or physicians. In the illustrated embodiment, the portable computer 102 requests a report for one particular physician, identified by identification number “1”. This physician identifier may correspond to a particular physician that logs-on to the portable computer 102. Similarly, the portable computer 102 communicates particular dates for which to generate a report by entering a starting date and an ending date in response to starting date prompt 1542 and ending date prompt 1544. The portable computer 102 may also select a particular location, such as an office or room number, by entering the specific location code in response to the selective location code prompt 1550.

As set forth above, in the preferred embodiment, the above-described responses to queries presented by the emulated terminal are input by a user via import setup display 1200. However, it will be appreciated that in alternative embodiments, such responses can be manually entered by the physician 106 during the terminal emulation via the portable computer 102. It will also be appreciated that the information entered at the import setup display 1200 can be pre-programmed in the code or written into a specific script file.

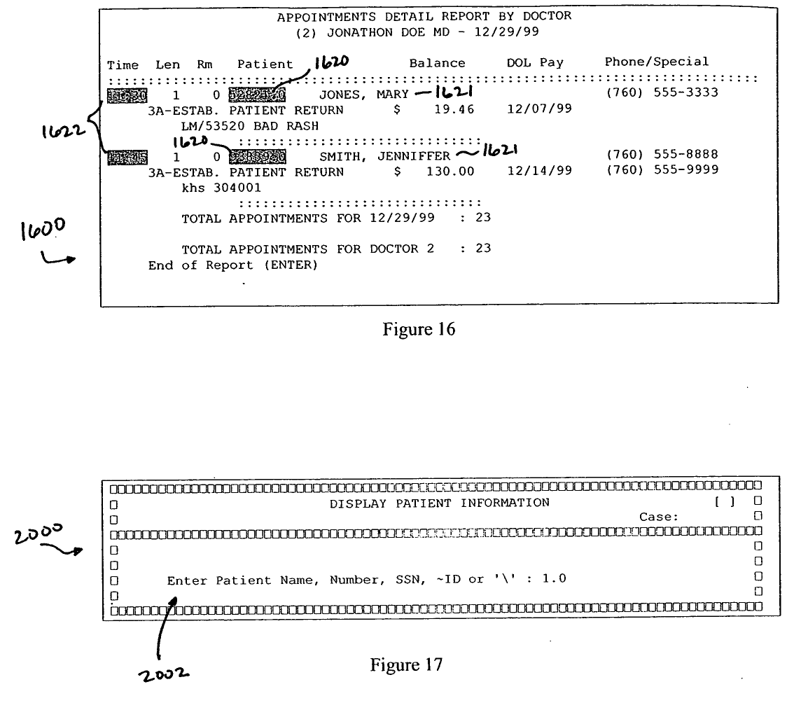

After the above-described responses have been entered, the portable computer 102 will emulate the appointment detail report display 1600 for the selected physicians, as illustrated in FIGS. 15 and 16. In some instances, physician office management information system 110 includes appointment detail reports for many different physicians. The portable computer 102 can enter the physician identifier in response to the prompts 1532, 1534 to obtain the appointment detail repots that corresponds to the one or more particular physicians. In this manner, the portable computer 102 need not import healthcare related information for every patient of every physician stored on the physician office management information system 110. FIGS. 15 and 16 illustrate a first and last page of an emulated report for a particular physician on a particular day, which includes patient identifiers 1620, 1621 and upcoming patient appointment times 1622. The portable computer 102 scrapes the emulated patient identifier 1620, in this case the patient number, and the emulated patient appointment times 1622 in the manner described above. The shaded areas in FIGS. 15 and 16 represent the data fields from which the healthcare related information is scraped.

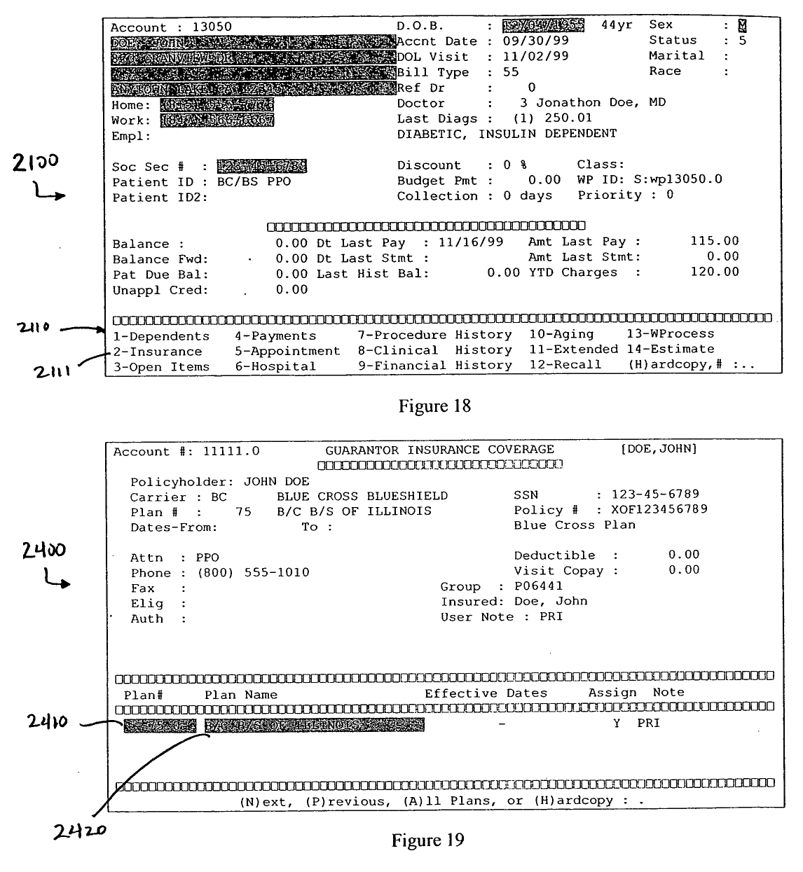

After the patient identifiers 1620 and upcoming patient appointment times 1622 have been scraped, the portable computer 102 again queries the emulated menu display 1400 and requests option 1406, “display patient data.” The portable computer 102 then emulates the patient information query display 2000 illustrated in FIG. 17. The portable computer 102 then enters a previously scraped and saved patient identifier in response to the prompt 2002, which causes the portable computer 102 to emulate the detailed patient display 2100 illustrated in FIG. 18. The emulated detailed patient display 2100 illustrated in FIG. 18 sets forth detailed information regarding the patient that corresponds to the patient identifier entered by the portable computer in response to the prompt 2002 illustrated in FIG. 17. As illustrated in FIG. 18, the emulated detailed patient display 2100 includes patient demographic information, such as the patient's name, address, telephone number, social security number, date of birth, sex, as well as other information, such as the patient's last diagnosis. The portable computer 102 then scrapes the patient's name, address, telephone number, social security number, date of birth, and sex from the emulated detailed patient display 2100 in the previously described manner. The shaded areas in FIG. 18 represent the data fields from which the healthcare related information is scraped.

As further illustrated in FIG. 18, the emulated detailed patient display 2100 also includes a lower menu 2110 through which the portable computer 102 can obtain further information concerning the patient. For example, the portable computer 102 may select the insurance option 2111 so as to cause the portable computer 102 to emulate the insurance information display 2400 illustrated in FIG. 19.

As illustrated in FIG. 19, the emulated insurance information display 2400 sets forth detailed information concerning the particular patient's insurance coverage, such as the plan number 2410, and the insurance plan name 2420. The portable computer 102 scrapes the plan number 2410 and the plan name 2420 from the emulated insurance information display 2400 in the previously described manner. The shaded areas in FIG. 19 represent the data fields from which the healthcare related information is scraped.

As will be appreciated, more or less of the previously described healthcare related information illustrated in FIGS. 15-19 may be scraped by the portable computer 102 in the previously described manner. For example, the portable computer 102 may scrape information regarding the patient's dependents, payment information, appointment information, hospitalization information, allergies, and other healthcare related information as will be apparent. Hence, the portable computer 102 may query any of the menu options illustrated in FIGS. 13 and 18 so as to obtain the previously described healthcare related information.

Referring again to FIG. 5, after the portable computer 102 has emulated and scraped the emulated healthcare related information into a memory of the portable computer 102, at a step 210 the portable computer is disconnected from the physician office management information system 110. As described further below, the physician 106 can then view and/or access the stored healthcare related information via the portable computer 102.

One embodiment of using the portable computer 102 is now described in reference to FIG. 6. To begin using the portable computer 102, at a step 301, the physician 106 logs-on to the portable computer 102 by entering a user name, password, or other unique identifier. For example, as illustrated in FIG. 9, the portable computer 102 presents an interactive log-on display 600 to the physician 106 during the log-on step 301. Hence, the physician 106 enters one or more unique identifier in the fields 602, 604 by using an interactive keyboard 610 or other similar communication module, such as a keyboard or graffiti pad.

After the physician 106 has logged-on to the portable computer 102, the physician 106, at a step 302, may initiate the importation of healthcare related information from the physician management information system 1 10 in the manner described above. Hence, the portable computer 102 will emulate a terminal of the physician office management information system 110, and scrape emulated healthcare related information into a memory of the portable computer 102. After the physician 106 has imported the healthcare related information, at a step 303, the physician 106 selects a patient from the patient schedule display 500 illustrated in FIG. 10. As illustrated in FIG. 10, the patient's schedule display 500 includes one or more columns of patient identifiers such as patient numbers and/or patient names, and a column of upcoming patient appointment times. Drop down windows 502, 504 allow the physician 106 to arrange the retrieved healthcare related information in a desired format. For example, the physician 106 may choose to view all patients, select patients of a certain age, select patients having a certain ailment, patients to be seen during a certain time frame, etc. The retrieved healthcare related information may also be automatically formatted according to predetermined parameters or according to default parameters. By selecting one of the patients listed on the patient schedule display 500, the portable computer 102 accesses the healthcare related information retrieved from the physician office management information system 110 for the patient selected by the physician 106.

After the portable computer 102 has retrieved the healthcare related information stored in the portable computer 102 for the selected patient, at a step 304, the physician 106 performs a healthcare related activity with the portable computer 102. For example, the physician 106 may desire to create a prescription for the selected patient. FIG. 11 illustrates one embodiment of a prescription creation display 800 by which the physician 106 may create a prescription for the selected patient. In a preferred embodiment, the portable computer 102 defaults to the prescription creation display 800 upon the physician 106 selecting a patient from the patient schedule display 500. Upon selecting a patient from the patient schedule display 500, the portable computer 102 retrieves the stored healthcare related information previously scraped by the portable computer 102, and incorporates the healthcare related information as needed in the prescription creation screen 800. Hence, as illustrated in FIG. 11, the prescription creation screen 800 for the selected patient includes one or more of the selected patient's identifiers and the selected patient's insurance information. The physician. 106 thus uses the scraped healthcare related information to create the prescription for the selected patient. The resulting prescription, whether electronic or paper, will include at least some of the scraped healthcare related information, such as the scraped patient identifier.

It will also be appreciated that the physician 106 can perform healthcare related tasks besides writing prescriptions at step 304. For example, the physician 106 may utilize the scraped healthcare related information to prepare medical orders, bills, hospital admission forms, order sets, dictation, lab orders, referrals, or complete another healthcare related activity. After the physician 106 has completed the healthcare related activity, in a step 305, relevant healthcare related information can be printed, stored, transmitted to external devices on the network 120, or purged from the memory of portable computer 102. Hence, the physician 106 can transmit healthcare related information from the portable computer 102 to external devices, such as printers, computers, facsimile machines, modems, pagers, cellular phones, and the like, in order that the healthcare related information can be utilized for other purposes. For example, the physician 106 may transmit a prescription to a pharmacy connected to the network 120, or transmit a bill to a third party.

Because the preferred embodiment of the present invention permits physicians to import healthcare related information from a physician office management information system, physicians do not have to continually print patient reports from the physician office management information system to perform healthcare related activities. Nor are physicians required with the preferred embodiment of the present invention to manually input, into portable computers, healthcare related information from a physician office management information system, as was conventionally required to perform healthcare related activities with the portable computer. Hence, the preferred method and apparatus of the present invention facilitate use of portable computers to perform various health related tasks.

The principles, preferred embodiments, and modes of operation of the present invention have been described in the foregoing description. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims be embraced thereby.

We claim:

1. A method of retrieving healthcare information, comprising:
connecting a portable computer to a physician office management information system, the physician office management information system storing healthcare related information including at least patient identifiers and upcoming patient appointment times;
emulating a terminal of the physician office management information system to obtain emulated healthcare related information; and
scraping patient identifiers and upcoming patient appointment times from the emulated healthcare related information into a memory of the portable computer.

2. The method of claim 1, further comprising:
disconnecting the portable computer from the physician office management information system; and
viewing with the portable computer at least some of the scraped patient identifiers and scraped upcoming patient appointment times stored in the memory.

3. The method of claim 1, further comprising:
creating with the portable computer a prescription having at least one of the scraped patient identifiers.

4. The method of claim 3, wherein the prescription is at least one of a paper prescription and an electronic prescription.

5. The method of claim 1, wherein said scraping includes:
locating and copying into the memory at least one data string from an emulated data field corresponding to a patient identifier; and
locating and copying into the memory at least one data string from an emulated data field corresponding to an upcoming patient appointment time.

6. The method of claim 1, wherein said scraping includes:
scraping each patient identifier into an assigned memory location, each of the assigned memory locations corresponding to a different patient identifier; and
scraping each upcoming patient appointment time into designated memory locations, each of the designated memory locations corresponding to an upcoming patient appointment time of a different patient.

7. The method of claim 1, further comprising purging the scraped patient identifiers and scraped upcoming patient appointment times from the memory.

8. The method of claim 1, further comprising transmitting the scraped patient identifiers to a device external to the portable computer.

9. The method of claim 1, further comprising:
retrieving at least some of the scraped patient identifiers and scraped upcoming patient appointment times from the memory and displaying the retrieved patient identifiers and retrieved upcoming patient appointment times in a desired arrangement, the desired arrangement including at least a column of patient identifiers and a column of upcoming patient appointment times.

10. The method of claim 1, further comprising:
selecting a date with the portable computer, said scraping upcoming patient appointment times from the emulated healthcare related information including only scraping upcoming patient appointment times that fall on the selected date.

11. The method of claim 1, further comprising:
scraping patient insurance information from the emulated healthcare related information into the memory of the portable computer.

12. The method of claim 11, wherein said scraping includes:
scraping insurance information for each patient into assigned memory locations, each of the assigned memory locations corresponding to insurance information of a different patient.

13. The method of claim 1, further comprising:
setting emulation settings for emulating the terminal of the physician office management information system, the emulation settings including at least one password.

14. The method of claim 1, wherein the memory is a persistent memory.

15. A portable computer, comprising:
a memory for storing scraped information; means for emulating a terminal of a physician office management information system to obtain emulated healthcare related information including at least patient identifiers and upcoming patient appointment times; and
means for scraping the patient identifiers and upcoming patient appointment times from the emulated healthcare related information into the memory.

16. The portable computer of claim 15, further comprising:
means for generating a prescription with at least one of the scraped patient identifiers.

17. The portable computer of claim 15, further comprising:
means for displaying the scraped patient identifiers and the scraped upcoming patient appointment times in a desired arrangement, the desired arrangement including at least a column of patient identifiers and a column of upcoming patient appointment times.

18. A method of using a portable computer to:
emulate a terminal of a physician office management information system to obtain emulated healthcare related information;
scrape at least patient identifiers and upcoming patient appointment times from the emulated healthcare related information into a memory of the portable computer; and
create a prescription.

19. Computer executable software code stored on a computer readable medium of a portable computer, the code for:
prompting a user of the portable computer to import information from a physician office management information system;
emulating a terminal of a physician office management information system to obtain emulated healthcare related information; and
scraping at least patient identifiers and upcoming patient appointment times from the emulated healthcare related information into a memory of the portable computer.

20. The computer executable software code of claim 19, further comprising code for creating a prescription having at least one of the scraped patient identifiers.

21. The computer executable software code of claim 19, said scraping including:
locating and copying into the memory at least one data string from an emulated data field corresponding to a patient identifier; and
locating and copying into the memory at least one data string from an emulated data field corresponding to an upcoming patient appointment time.

22. The computer executable software code of claim 19, further comprising code for: scraping patient insurance information from the emulated healthcare related information into the memory of the portable computer.

23. A computer program product having computer-executable software code stored thereon for use with a portable computer, the code comprising:
code responsive to an emulation command to emulate a terminal of a physician office management information system to obtain emulated healthcare related information; and
code responsive to a scrape command to scrape at least patient identifiers and upcoming patient appointment times from the emulated healthcare related information into a memory of the portable computer.

24. The computer program product of claim 23, wherein said code responsive to a scrape command is operable to locate and copy into the memory at least one data string from an emulated data field corresponding to a patient identifier locate and copy into the memory at least one data string from an emulated data field corresponding to an upcoming patient appointment time.

25. A method of managing healthcare related information, comprising:
connecting a portable computer corresponding to a specific physician to a physician office management information system, the physician office management information system storing a plurality of patient appointment schedules each corresponding to a different physician;
emulating a terminal of the physician office management information system to obtain emulated healthcare related information that includes a patient appointment schedule that corresponds to the specific physician; and
scraping emulated patient appointment schedule information that corresponds to the specific physician from the emulated healthcare related information into a memory of the portable computer.

26. The method of claim 25, further comprising creating a prescription with the portable computer.

27. A method comprising:
creating a prescription with a portable computer using healthcare related information scraped from a plurality of predetermined fields of a physician office management information system.
